(19) United States
(12) Patent Application Publication
(10) Pub. No.: US 2026/0087575 A1
(43) Pub. Date: Mar. 26, 2026

(54) SYSTEMS AND METHODS FOR GENERATING SYNTHESIZED REFERENCE MATERIALS USING MACHINE LEARNING

(71) Applicants: Constructor Technology AG, Schaffhausen (CH); Constructor Education and Research Genossenschaft, Schaffhausen (CH)

(72) Inventors: Sergey ULASEN, Singapore (SG); Andrey ADASCHIK, Istanbul (TR); Ilya BAIMETOV, Redmond, WA (US); Alexander TORMASOV, Busingen am Hochrhein (DE); Serg BELL, Singapore (SG); Stanislav PROTASOV, Singapore (SG); Nikolay DOBROVOLSKIY, Alanya (TR); Laurent DEDENIS, Singapore (SG)

(21) Appl. No.: 18/894,503

(22) Filed: Sep. 24, 2024

(51) Int. Cl. G06Q 50/20; G06N 20/20; G06Q 30/0282

(52) U.S. Cl. CPC G06Q 50/205; G06N 20/20; G06Q 30/0282

(57) ABSTRACT

Disclosed herein are systems and method for generating synthesized content using machine learning. A method may include: receiving, via a UI, a first user selection of a topic from a plurality of topics; identifying a first reference material and a second reference material from a plurality of reference materials related to the topic; determining a first complexity level and a first quality level of the first reference material; determining a second complexity level and a second quality level of the second reference material; calculating a weight distribution that is a combination of a ratio between the complexity levels and a ratio between the quality levels; executing a machine learning algorithm that generates content synthesized from both the first reference material and the second reference material based on the weight distribution; and outputting, for display, the content on the UI.

### FIELD OF TECHNOLOGY

The present disclosure relates to the field of machine learning, and, more specifically, to systems and methods for generating synthesized reference materials using machine learning.

### BACKGROUND

In the realm of machine learning, the task of merging information from different sources poses a significant challenge. As the volume and variety of data continue to expand exponentially across various domains, from social media platforms to scientific research databases, the need to effectively integrate these diverse sources becomes increasingly pressing. However, achieving seamless integration is far from trivial, as machine learning systems grapple with numerous obstacles ranging from inconsistencies in data formats and structures to inherent biases embedded within different sources.

### SUMMARY

In one exemplary aspect, the techniques described herein relate to a method for generating synthesized content using machine learning, the method including: receiving, via a user interface (UI), a first user selection of a topic from a plurality of topics; identifying a first reference material and a second reference material from a plurality of reference materials related to the topic; determining a first complexity level and a first quality level of the first reference material; determining a second complexity level and a second quality level of the second reference material; calculating a weight distribution that is a combination of a ratio between the first complexity level and the second complexity level and a ratio between the first quality level and the second quality level; executing, by a hardware processor, a first machine learning algorithm that generates content synthesized from both the first reference material and the second reference material based on the weight distribution; and outputting, for display on the UI, the content synthesized from both the first reference material and the second reference material.

In some aspects, the techniques described herein relate to a method, wherein calculating the weight distribution further includes: determining a first accuracy level of the first reference material; determining a second accuracy level of the second reference material; and calculating the weight distribution further based on a ratio between the first accuracy level and the second accuracy level.

In some aspects, the techniques described herein relate to a method, wherein identifying the first reference material and the second reference material includes: generating, for display on the UI, at least a portion of each of the plurality of reference materials; and receiving, via the UI, a selection of a subset of reference materials from the plurality of reference materials, wherein the first reference material and the second reference material are in the subset of reference materials.

In some aspects, the techniques described herein relate to a method, wherein identifying the first reference material includes: receiving, via the UI, at least one of the first reference material or a link to the first reference material.

In some aspects, the techniques described herein relate to a method, wherein determining the first accuracy level and the second accuracy level includes: executing a second machine learning algorithm trained to generate an accuracy level based on one or more of an input genre of a given reference material, a fact checking score of the given material, and a publication date of the given reference material.

In some aspects, the techniques described herein relate to a method, wherein determining the first complexity level and the second complexity level includes: executing a second machine learning algorithm trained to generate a complexity level based on one or more of: (1) a number of terms, topics, subtopics used in a given reference material, (2) an amount of time needed to complete the given reference material, (3) expert estimations, (4) large language model (LLM) output, (5) grades of students in exams of a corresponding topic covered in the given reference material, (6) complexity levels of reference materials used in required prerequisites of the course.

In some aspects, the techniques described herein relate to a method, wherein determining the first quality level and the second quality level includes: executing a third machine learning algorithm trained to generate a quality level based on online reviews including user ratings and written descriptions.

In some aspects, the techniques described herein relate to a method, further including: web crawling the online reviews; parsing the online reviews by: determining a frequency of words in the online reviews; and identifying trigger words indicative of low quality in the online reviews; and including frequencies of the trigger words and the user ratings in an input vector.

In some aspects, the techniques described herein relate to a method, wherein the topic includes a plurality of sub-topics, wherein information of each sub-topic in the plurality of sub-topics is outputted in a different visual panel of the UI.

In some aspects, the techniques described herein relate to a method, wherein respective content for each sub-topic is synthesized from a different subset of reference materials from the plurality of reference materials.

In some aspects, the techniques described herein relate to a method, further including: receiving, via the UI, a user selection of a preferred duration of the content; and adjusting a length of the content such that it is consumed within the preferred duration.

It should be noted that the methods described above may be implemented in a system comprising a hardware processor. Alternatively, the methods may be implemented using computer executable instructions of a non-transitory computer readable medium.

In some aspects, the techniques described herein relate to a system for generating synthesized content using machine learning, including: at least one memory; and at least one hardware processor coupled with the at least one memory and configured, individually or in combination, to: receive, via a user interface (UI), a first user selection of a topic from a plurality of topics; identify a first reference material and a second reference material from a plurality of reference materials related to the topic; determine a first complexity level and a first quality level of the first reference material; determine a second complexity level and a second quality level of the second reference material; calculate a weight distribution that is a combination of a ratio between the first complexity level and the second complexity level and a ratio between the first quality level and the second quality level; execute a first machine learning algorithm that generates content synthesized from both the first reference material and the second reference material based on the weight distribution; and output, for display on the UI, the content synthesized from both the first reference material and the second reference material.

In some aspects, the techniques described herein relate to a non-transitory computer readable medium storing thereon computer executable instructions for generating synthesized content using machine learning, including instructions for: receiving, via a user interface (UI), a first user selection of a topic from a plurality of topics; identifying a first reference material and a second reference material from a plurality of reference materials related to the topic; determining a first complexity level and a first quality level of the first reference material; determining a second complexity level and a second quality level of the second reference material; calculating a weight distribution that is a combination of a ratio between the first complexity level and the second complexity level and a ratio between the first quality level and the second quality level; executing, by a hardware processor, a first machine learning algorithm that generates content synthesized from both the first reference material and the second reference material based on the weight distribution; and outputting, for display on the UI, the content synthesized from both the first reference material and the second reference material.complexity levelcomplexity levelcomplexity level

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating custom courses on a user interface (UI) using machine learning.

FIG. 2A is a diagram illustrating a UI accepting a topic selection.

FIG. 2B is a diagram illustrating a UI accepting reference materials for a new topic.

FIG. 3 is a diagram illustrating the UI receiving reference material selections for synthesis.

FIG. 4 is a diagram illustrating the UI displaying a generated course.

FIG. 5 is a diagram illustrating content from two different reference materials being synthesized for display on the UI.

FIG. 6 is a block diagram illustrating a method for generating a user interface with synthesized reference materials using machine learning.

FIG. 7 presents an example of a general-purpose computer system on which aspects of the present disclosure can be implemented.

FIG. 8 is a block diagram illustrating a system for training course generator to generate custom courses according to aspects of the present disclosure.

### DETAILED DESCRIPTION

Exemplary aspects are described herein in the context of a system, method, and computer program product for generating custom courses on a user interface (UI) using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes the formalization/unification of disparate sources of information during course creation. When creating a course, different sources can be considered, where each source describes the same concepts in different terms and at different degrees of depth. The present disclosure presents a system that automatically finds these concepts, compares them with each other, and replaces it with a single formal system.

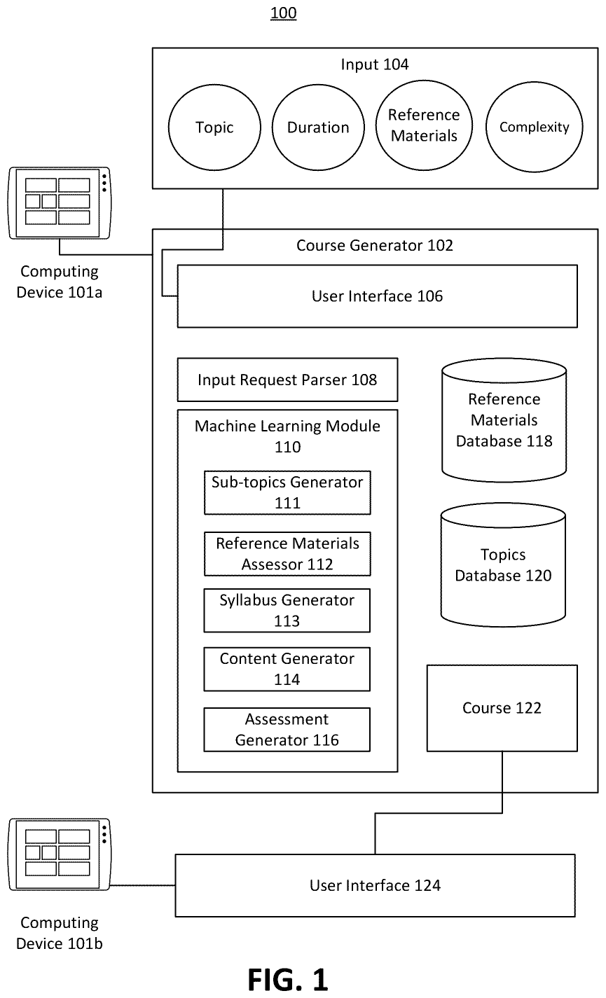

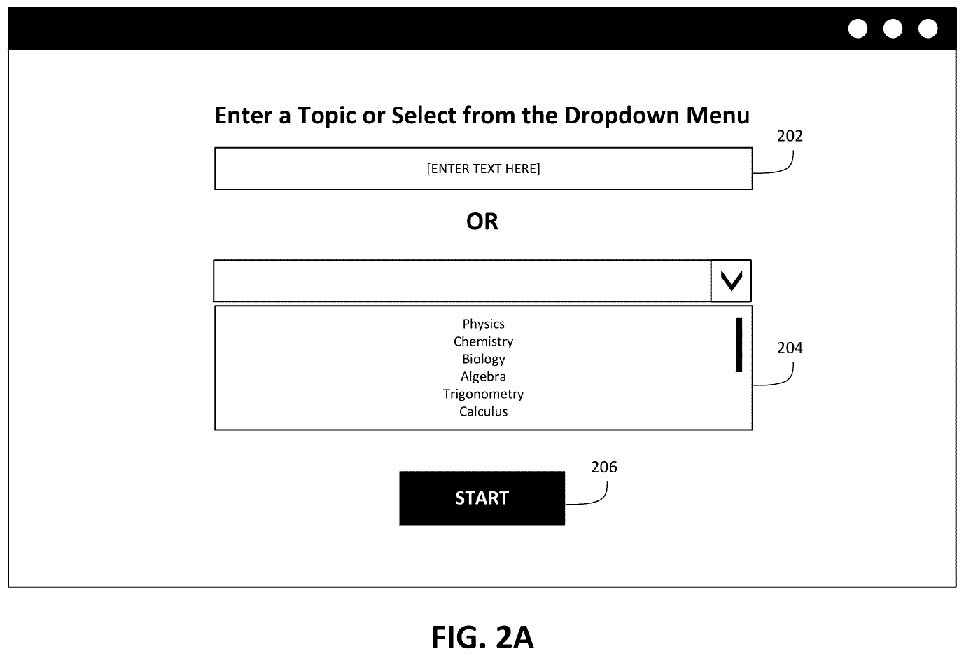

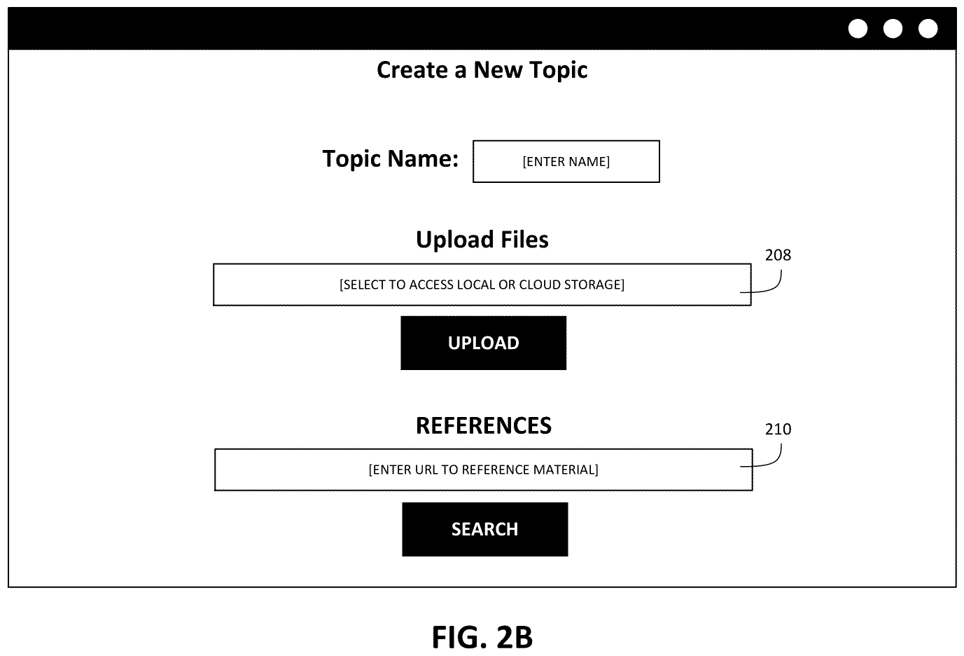

FIG. 1 is a block diagram illustrating system 100 for generating custom courses on a UI using machine learning. In particular, system 100 features course generator 102, which may be a software installed on or accessed (e.g., via a virtual machine, container, web application) on computing device 101a. Course generator 102 includes a UI 106, which is described in FIGS. 2-5, input request parser 108, machine learning module 110, reference materials database 118, and topics database 120. Course generator 102 is configured to generate course 122 for display on UI 106. In some aspects, course generator 102 may transmit course 122 to user interface (UI) 124, which is part of a client application associated with course generator 102. UI 124 may be generated by computing device 101b. For example, computing device 101a may be a device belonging to an educator (e.g., a teacher, a tutor, etc.) and computing device 101b may be a device belonging to a student that is taught by the educator. Alternatively, course 122 may be generated by a student on UI 106 for self-learning.

In some aspects, the UI may be presented via a graphical device (e.g., a graphical user interface), text terminal, chat interface, or internal chat interface by agents or similar, which can receive inputs from a user, or from another ML algorithm generated as a result of its work locally or remotely.

The present disclosure discusses the use of artificial intelligence (AI) (e.g., large language models (LLM)) to create courses for teachers and students using multiple different reference materials. LLMs are a type of AI model designed to understand and generate human-like text based on vast amounts of data. These models are built using deep learning techniques, particularly variants of recurrent neural networks (RNNs) or transformer architectures. The following is a breakdown of key components and characteristics.

LLMs are trained on massive datasets composed of text from various sources such as books, articles, websites, and other written material. The models learn the statistical patterns, syntactic structures, and semantic relationships present in the data.

LLMs are characterized by their large scale, both in terms of the size of the training data and the complexity of the model architecture. They typically contain millions or even billions of parameters, enabling them to capture intricate linguistic nuances.

Many modern LLMs are based on transformer architectures. Transformers have revolutionized natural language processing (NLP) tasks by enabling efficient parallelization and capturing long-range dependencies in text. LLMs are often pre-trained on a large corpus of text using unsupervised learning techniques. During pre-training, the model learns to predict the next word or sequence of words in a sentence given preceding context. After pre-training, the model can be fine-tuned on specific downstream tasks, such as language translation, text summarization, or sentiment analysis. One of the distinguishing features of LLMs is their ability to generate coherent and contextually relevant text. Given a prompt or starting text, the model can generate plausible continuations or completions that resemble human-written text. This capability has numerous applications, including content creation, dialogue systems, and language translation.

In an exemplary aspect, an LLM may be used to synthesize two or more educational reference materials. The synthesized material may be a singular course 122, which is presented via a UI. Machine learning module 110 may comprise of one or more machine learning algorithms, of which content generator 114 may be an LLM.

Training content generator 114 to synthesize text from two or more educational materials involves several steps. The first step is to gather the reference materials that will be included in a training dataset. These materials may include, but are not limited to, textbooks, research papers, articles, lecture transcripts, or any other text-based educational content. In some aspects, the materials gathered may be directed to a singular topic (e.g., “biology”). As a result, to accommodate multiple topics (e.g., “chemistry,” “algebra,” “investing,” “photography,” etc.), multiple LLMs may be trained (i.e., one for each topic). Machine learning module 110 may further perform preprocessing on the text. For example, machine learning module 110 may perform tasks such as tokenization, where the text is split into individual words or sub-word units, and cleaning the data to remove any irrelevant or noisy information.

Suppose that content generator 114 has a transformer-based architecture. During pre-training, content generator 114 is configured, using the gathered materials, to predict the next word or sequence of words in a sentence given preceding context. The objective of pre-training is to teach content generator 114 general language representations and patterns from the data. This involves tasks like predicting the next word in a sentence given the preceding context. Pre-training may involve using unsupervised learning techniques, meaning that content generator 114 learns from the raw text data without any specific task-oriented supervision. The pre-training phase aims to provide content generator 114 with a broad understanding of the structure and semantics of natural language, enabling it to perform well across various downstream tasks.

After pre-training, content generator 114 is fine-tuned on a specific task related to synthesizing text from educational materials. This could involve providing the model with pairs of sentences or paragraphs from different educational sources and asking it to generate coherent summaries or explanations that integrate information from both sources. In fine-tuning, the pre-trained content generator 114 is provided with labeled pairs of input-output data for tasks such as text summarization, sentiment analysis, or question-answering. The objective of fine-tuning is to adapt the pre-trained model's learned representations to the nuances and requirements of the target task, which may involve adjusting the model's parameters to better fit the new data or task. Fine-tuning may utilize supervised learning techniques, where the model learns from labeled data with clear synthesizing objectives.

In some aspects, content generator 114 may be trained to perform synthesis based on various factors. For example, each reference material may be weighted in a specific manner based on the following: (1) an accuracy level, which factors in favored types of materials (e.g., non-fiction references may be favored over fiction references), inconsistencies with neighboring materials (e.g., materials that indicate facts that do not align with other materials in the same field), and whether the material is up-to-date (e.g., references published more recently may be favored over older references), (2) a quality level, which considers authenticity, how well the material is reviewed, etc. (e.g., papers that are published may be more favored than unpublished works), and/or (3) complexity level (e.g., elementary school level, high-school level, etc.). Content generator 102 then generates the course using an LLM by extracting topics/concepts/activities from the materials and synthesizing them into a unique body of information.

The performance of content generator 114 is evaluated based on a validation set to ensure that it is synthesizing text accurately and effectively. This may involve metrics such as a bilingual evaluation understudy (BLEU) score (for measuring the similarity between generated text and reference summaries). A BLEU score is a metric generally used to evaluate the accuracy of machine-translated text. For example, a score may range from 0 to 1, with higher scores indicating better translation.

In an exemplary scenario, a teacher may indicate a topic (e.g., introduction to physics) and duration (e.g., 30 hours) of the course and may provide third party materials (e.g., textbooks, scientific papers, presentations, videos, media, etc.) to include in the course using UI 106. Machine learning module 110 comprising one or more machine learning models (e.g., sub-topics generator 111, reference materials assessor 112, syllabus generator 113, content generator 114, and assessment generator 116) may analyze the user specified sources, as well as other known sources (e.g., stored in reference materials database 118), to generate a syllabus for the course that includes various topics and subtopics. The machine learning module may further fill each lesson of the course with content synthesized from various reference materials using machine learning. The synthesized content may be assembled into a book or multiple slide presentations, which serve as the output of the machine learning module 110.

In an exemplary aspect, course generator 102 populates topics database 120. Topics database 120 includes a plurality of topics (e.g., “biology,” “chemistry,” “physics,” etc.), each of which include a plurality of sub-topics. For example, the user may provide a plurality of reference materials to course generator 102. Reference materials include, but are not limited to, textbooks, non-fiction books, webpages, e-books, videos, graphics, research papers, patents, etc. In some aspects, the user may provide, to course generator 102, a copy of the reference material(s) or may provide links to the reference material(s) for course generator 102 to web crawl. The user may label the reference materials as part of a topic. For example, the user may type in a topic in UI 106, and upload reference materials (see FIG. 2B). All provided reference materials are stored in reference materials database 118.

Given a set of reference materials for the topic, machine learning module 110 is configured to identify various sub-topics of the topic. For example, if the topic is “poetry,” a sub-topic may be a particular type of poetry or a famous poet. In order to identify the sub-topics, course generator 102 may refer to the chapter titles of the reference materials (e.g., video names, slide titles, textbook chapter titles, etc.) and identify each unique title as a sub-topic. In another approach, sub-topics generator 111 of machine learning module 110 may be used to execute an algorithm such as Latent Dirichlet Allocation (LDA).

In some aspects, input request parser 108 may clean the provided/linked text data by removing stop words, punctuation, and irrelevant characters. Input request parser 108 may further break down the cleaned text into individual words or tokens. This step prepares the data for analysis on a word level. Sub-topics generator 111 may then create a document term matrix (DTM) that represents the frequency of each term (word) in each document (e.g., textbook, webpage, etc.). Each row of the DTM may correspond to a document, and each column may correspond to a unique term, with the matrix cells including the frequency of each term in the respective document. Sub-topics generator 111 may then apply the LDA algorithm to the DTM. LDA assumes that each document is a mixture of sub-topics, and each sub-topic is a mixture of words. The algorithm iteratively assigns words to sub-topics based on the distribution of topics across documents. Furthermore, sub-topics generator 111 assigns each document a probability distribution over topics, and each word is assigned to a specific sub-topic with a certain probability. Sub-topics generator 111 may identify the most probable sub-topics for each document based on the assigned probabilities. This step involves looking at the words with the highest probability in each sub-topic and interpreting them to label the sub-topics.

Using the method described above, sub-topics generator 111 is able to identify the most common words in each topic/subtopic. Said words are stored in a glossary of the topic, which is further recorded in topics database 120. In particular, the glossary indicates multiple words and a weight of each word. The weight of the word may be determined based on a frequency at which each word appears in the reference materials. For example, for a sub-topic such as “photosynthesis” in the topic “biology,” terms such as “sunlight” and “carbon dioxide,” which appear frequently in relation to “photosynthesis” in the reference materials may be weighted higher than “night,” and “hydrogen,” which appear less frequently. For example, the weight of “sunlight” may be 1.1, while the weight of “night” may be 0.2. This suggests that in a summary, the words with higher weights should be preferred for inclusion than words with lower weights. This may be because less common words are probably specific to one textbook or niche ideas.

Reference materials assessor 112 of machine learning module 110 may also be configured to assign a quality level to each reference material in reference materials database 118. A quality level represents a reliability and general preference of a textbook as expressed in a quantitative value. For example, a university level textbook on “biology” may be a high quality material, where as a fiction novel about “biology” may be a low quality material. Assessing the quality of multiple reference materials using machine learning involves defining and extracting features that represent various aspects of a material's quality. Reference materials assessor 112 may define objective metrics (e.g., readability scores, grammatical correctness, and the complexity of sentence structures) and subjective metrics (e.g., metrics based on expert reviews, user ratings, or feedback from educators and students) for each reference material. In particular, the subjective metrics may be useful in determining how authentic a reference material is. For example, if scientists indicate that the research in a paper is flawed, the quality level of the paper will be low. In particular, reference materials assessor 112 may web crawl reviews associated with the reference material—extracting ratings and written reviews. For written reviews, reference materials assessor 112 may determine a frequency of words from all reviews and search for specific trigger words that indicate low quality (e.g., “flawed,” “incorrect,” “poorly written,” etc.). The frequency of said trigger words and the user ratings are then entered in an input vector for the reference material. Using these metrics, reference materials assessor 112, which may be a trained classification model, may output a quality level for each reference material. In some aspects, a quality level may be a quantitative value (e.g., a rating out of 10) or a qualitative value (e.g., “low,” “medium,” “high,” etc.).

Reference materials assessor 112 of machine learning module 110 may also be configured to assign a complexity level to each reference material in reference materials database 118. For example, a university level textbook on “biology” may be a high difficulty material, where as an elementary school textbook about “biology” may be a low difficulty material. Reference materials assessor 112 may define metrics such as complexity of sentence structures, word length, recommended age groups, target grade level, volume of the materials and topics, assumed deepness of explanation and required background, etc., for each reference material (e.g., based on the human feedback and experts preferences). Using these metrics, reference materials assessor 112, which may be a trained classification model, may output a complexity level for each reference material. In some aspects, a complexity level may be a quantitative value (e.g., a rating out of 10) or a qualitative value (e.g., “low,” “medium,” “high,” etc.). In some aspects, human can reevaluate and change (update or create own) complexity levels based on, for example, recommendations by model estimations. Reference materials assessor 112 may execute a machine learning model trained to generate a complexity level based on one or more of: (1) a number of terms, topics, subtopics used in the reference material, (2) an amount of time needed to complete the reference material, (3) expert estimations, (4) large language model (LLM) output, (5) grades of students in exams of corresponding topics covered in the reference material, (6) complexity levels of reference materials used in required prerequisites of the course. In terms of (1), reference materials assessor 112 may determine whether the amount of terms, subtopics, and/or topics described exceeds a threshold amount—the more words and topics to learn, the greater the complexity of the reference material. In terms of (2), word count can influence the amount of time needed to consume the reference material—the longer the material, the greater the complexity. In terms of (3) and (4), a known attribute of the reference material may indicate the complexity of the material (e.g., it may be known that a particular textbook is used for high schoolers and another textbook is used for university students). In terms of (5), if the subject matter covered in the course itself is difficult (e.g., quantum mechanics), the complexity of the reference material is expected to be high—the grades of students are an indication of the course difficulty. In terms of (6), in order to understand a particular reference material, a student may need to understand other topics covered in different reference materials. The complexity of those reference materials is taken into account when calculating the current reference material's complexity level.

Reference materials assessor 112 of machine learning module 110 may also be configured to assign an accuracy level to each reference material in reference materials database 118. An accuracy level quantifies a combination of favored types of materials (e.g., non-fiction references may be favored over fiction references), inconsistencies with neighboring materials (e.g., materials that indicate facts that do not align with other materials in the same field), and whether the material is up-to-date (e.g., references published more recently may be favored over older references). Reference materials that are recent, are not inconsistent with other references, and feature facts (instead of, for example, fantasy or science fiction) are deemed more accurate than reference materials that do not have such qualities.

In order to train reference materials assessor 112 to calculate an accuracy level, the training dataset may include input vectors that each indicate a genre of the material (e.g., non-fiction, fantasy, horror, etc.), a score produced by a fact checker (manually or automated) (e.g., the score may be out of 10 with higher numbers being associated with greater factual accuracy), and a publication date. The output may be a manually labeled accuracy level. In this case, reference materials assessor 112 may be a regression algorithm.

Course generator 102 stores reference materials and their respective accuracy levels, quality levels, and complexity levels in reference materials database 118.

It should be noted that prior to first use of course generator 102 for generating courses, the topics database 120 and reference materials database 118 needs include at least one topic and at least one reference material pertaining to the topic. A developer of course generator 102 may populate the software with multiple topics and reference materials for each topic. Afterwards, users can add topics and reference materials individually. In some aspects, topics database 120 and reference materials database 118 may be synchronized across multiple computing devices running course generator 102. For example, multiple schools or communities may share newly created topics and reference materials over a cloud database. As a result, any of a topic, reference material, course, etc., generated on one computing device may be transmitted by course generator 102 to a different computing device over a network (e.g., a local area network (LAN), a wide area network (WAN), etc.) for display on a UI.

Suppose that a user launches course generator 102 on computing device 101a to generate a course 122 on UI 106. In an exemplary aspect, UI 106 receives input 104, which may include a topic and, in some aspects, any of a duration, a difficulty, and preferred reference materials. For example, the topic in input 104 may be “biology.” Input request parser 108 may search for the topic in topics database 120. In response to finding a match, course generator 102 may output course 122 on UI 106.

A course has several means of configuration including, but not limited to, the selection of topic, selection of sub-topics, selection of reference materials, selection of duration, selection of difficulty, glossary customization, etc. In some aspects, some configurations may be set on a course level (e.g., a duration or difficulty of an entire course) and some configurations may be set on a sub-topic level (e.g., a duration of a particular lesson on a sub-topic). In response to receiving a generic input (e.g., “biology”), course generator 102 may generate course 122 using default configurations (e.g., a default set of sub-topics, difficulty, duration, etc.). In some aspects, the default configurations may be set by course generator 102 based on user preferences. For example, when creating a user profile, the user may indicate that he/she is in the 12^{th} grade. Based on this information, course generator 102 may set the difficulty of a course to “high school” level, may set the duration to 170 hours (accounting for an hour per school day), and may use high school textbooks to generate course content.

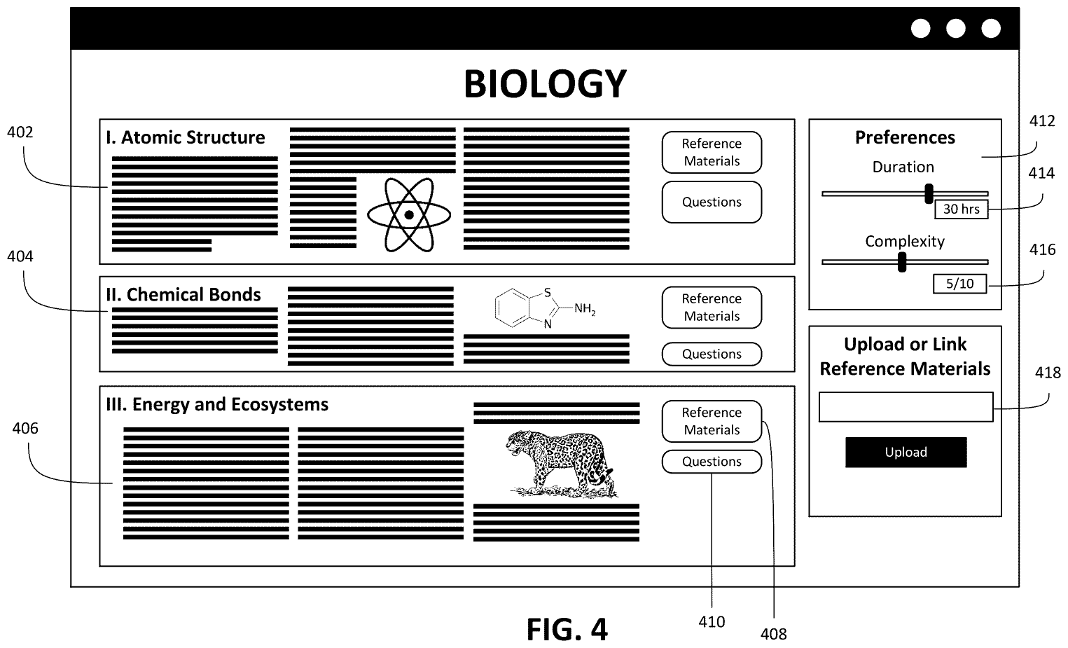

In some aspects, course generator 102 may generate queries on UI 106 to acquire more preferences by the user. For example, course generator 102 may generate a prompt that requests the user to select the sub-topics of interest. Course generator 102 may also generate panels that include configuration options (see FIG. 4). For example, a user may be able to adjust the difficulty or duration of a course, while course generator 102 adjusts the content generated for a particular sub-topic.

In terms of course generation, syllabus generator 113 is configured to generate a structure of the course. Based on the selection of a topic, sub-topics, duration, difficulty, reference materials, etc., syllabus generator 113 outputs a plurality of course attributes. For example, the course attributes may indicate that the course has three sub-topics to be covered over nine hours on an intermediate difficulty. To achieve a nine hour duration, syllabus generator 113 allocates three hours for each sub-topic. To achieve three hours for each sub-topic, syllabus generator 113 limits a word limit of the content to 24000 (accounting for 200 word per minute reading speed), an assessment limit of 20 questions, and a media limit (e.g., a video) of 20 minutes. To achieve the difficulty constraints, reference materials matching the complexity level are specified. For simplicity, all of these configurations are kept the same for each sub-topic in this example. However, a user may specify sub-topic level preferences, which may change these numbers. Furthermore, word limits may change based on the complexity level as well as both duration and difficulty may affect each other. For example, at an elementary school level, the reading speed is significantly slower and comprehension skills are lower than at a university level. Accordingly, syllabus generator 113 may output lower word limits to accommodate.

In order to produce accurate structures, machine learning module 110 trains syllabus generator 113, which may be a regression model, using a training dataset that includes several input vectors and corresponding output vectors. The input vectors may each include user preference fields such as topic, sub-topic count, duration, difficulty, sub-topic level preferences, etc. The corresponding output vectors may each include course attribute fields with the ideal word limits, media limits, question limits, etc., per sub-topic. By training syllabus generator 113 to generate the output vectors based on the input vectors, syllabus generator 113 is able to recommend a plurality of course attributes for any set of course configurations provided in input 104.

Content generator 114 receives the course attributes and generates content for each sub-topic. In particular, the content comprises a summary, graphics, media, assessments (e.g., questions, projects, etc.), and recommended supplemental readings generated using one or more reference materials.

Generating summaries from multiple reference materials in reference materials database 118 using machine learning involves leveraging natural language processing (NLP) and text summarization techniques. In one aspect, content generator 114 may perform tokenization on each of the reference materials above a threshold quality level and a threshold accuracy level and that match a complexity level preferred/specified by the user. Content generator 114 converts the tokenized text into numerical representations using techniques like Term Frequency-Inverse Document Frequency (TF-IDF) or word embeddings (e.g., Word2Vec, GloVe). This step captures the semantic meaning of words. In some aspects, content generator 114 may employ one or both of abstractive and extractive summarization approaches. Abstractive summarization involves generating new sentences to convey the summary, while extractive summarization selects and rearranges existing sentences.

In a supervised learning approach, content generator 114 is trained on labeled data with summaries corresponding to the reference materials. Accordingly, content generator 114 learns the relationship between the content and its corresponding summary. In an unsupervised learning approach, content generator 114 may use graph-based methods (e.g., TextRank) or clustering algorithms to identify and select the most important sentences. The length of the summary is bound to the course attribute indicated by syllabus generator 113. For example, if the word limit is 24000, the summary will include sentences extracted and/or abstracted from the reference materials that include no more than 24000 words. Because the reference materials are filtered based on quality, accuracy, and difficulty, content generator 114 generates tailored summaries for the user.

In an exemplary aspect, when selecting the sentences to include in the summary, content generator 114 refers to the glossary in topics database 120—specifically the glossary terms corresponding to a particular sub-topic. The weights of the words indicate which words are more important than others. Thus, the sentences extracted from reference material are likely to include words with higher weights. Likewise, self-generated sentences are likely to include words with higher weights. In some aspects, a user may access the glossary and adjust weights. In fact, a user may opt to add words and remove words depending on their learning preferences.

In some aspects, the extracted sentences from the reference materials may include mentions of graphics. For example, a textbook passage may refer to a textbook image. Accordingly, content generator 114 includes the mentioned graphic in the generated content. In another example, a website may include a link to a video on a video streaming website. Accordingly, content generator 114 includes the link to the video in the generated content.

The synthesis process involves combining selected elements from two or more reference materials while balancing difficulty, accuracy, and quality levels. This could be achieved through techniques such as sentence blending, paraphrasing, reordering, and restructuring. For example, an LLM of content generator 114 may prioritize maintaining accuracy and quality while adjusting the complexity level to meet specific requirements. The LLM may also employ techniques like smoothing transitions between excerpts from different texts to ensure a seamless synthesis.

Consider an example where two texts are being synthesized to create educational content about climate change.

Text A: Provides a detailed scientific explanation of greenhouse gas emissions and their impact on global warming. It's written at an advanced level with technical terminology. Accuracy Level: 10/10, Quality Level: 10/10, Complexity level: 10/10

Text B: Offers a simplified overview of climate change, focusing on its causes and effects in everyday language. It's written at an intermediate level and includes relatable examples. Accuracy Level: 9/10, Quality Level: 8/10, Complexity level: 7/10

During the synthesis process, content generator 114 may prioritize accuracy by selecting key scientific concepts and data from Text A as it has the higher accuracy level. In some aspects, the ratio between respective accuracy levels, complexity levels, and quality levels dictate the synthesis. For example, the ratio between text A and B for accuracy is 10:9, for quality is 10:8, and for difficulty is 10:7. Content generator 114 may determine a weight distribution as a combination of these ratios (e.g., the average ratio, the mean ratio, the mode ratio, etc.). For example, the average ratio is 10:8, which may be interpreted as 10 sentences in the synthesized content being generated based on text A and 8 sentences in the synthesized content being generated based on text B.

In an exemplary aspect, the complexity level may be set by the user. For example, the user may desire the synthesized content to have a difficulty rating of 6/10. In this case, only reference materials at or below this difficulty are selected. The weight distribution is subsequently determined based on the ratios between accuracy level and quality level. For example, content generator 114 may generate content from two reference materials, each with a difficulty rating of 6/10. Content generator 114 may determine the weight distribution of each material using the accuracy levels and quality levels, and generate the content accordingly.

Assessment generator 116 is configured to generate one or more of questions, short quizzes, tests, lab projects, etc., based on the generated content. For example, assessment generator 116 may be a generative neural network that receives the summary generated by content generator 114 and creates questions with answers found in the summary. If the summary says “the mitochondria is an organelle in which respiration and energy production occur,” assessment generator 116 may generate the question “which organelle is responsible for respiration and energy production?”. In some aspects, assessment generator 116 may identify questions found in the reference materials associated with the sub-topic. For example, if the summary includes information about the mitochondria, assessment generator 116 may identify a question in the reference material about the mitochondria. In some aspects, assessment generator 116 compares the sentences in the summary to the sentences in the questions. Based on a correspondence, assessment generator 116 determines whether the question is a candidate for inclusion in the generated content. It should be noted that the number of questions or types of assessments produced by assessment generator 116 is indicated in the course attributes generated by syllabus generator 113.

In some aspects, course generator 102 is equipped with sophisticated feedback algorithms that actively monitor student progress and adapt the generated content in real-time. The feedback algorithms recognize areas where students excel or struggle (e.g., like in differentiating between their grasp on derivatives and integrals in calculus). Based on this insight, course generator 102 may proactively offer supplementary modules, interactive tutoring sessions, or even adjust the main course content to better suit the student's learning pace and style. These real-time adjustments are powered by an intricate analysis of student performance, feedback, and learning patterns—ensuring that each student's learning journey is as effective and personalized as possible.

In general, machine learning module 110 may comprise one or more machine learning algorithms, which can broadly be categorized into three main types: supervised learning, unsupervised learning, and reinforcement learning.

Supervised learning is effective for tasks such as classification (assigning inputs to predefined categories) and regression (predicting continuous values). It relies on the availability of labeled data for both training and evaluation phases. In supervised learning, machine learning module 110 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, machine learning module 110 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, machine learning module 110 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine learning module 110 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

Unsupervised learning is valuable for tasks where the goal is to explore the inherent structure of the data, identify hidden patterns, or pre-process data for further analysis. It doesn't require labeled examples but relies on the algorithm's ability to discern meaningful structures within the input data. Unsupervised learning deals with unlabeled data, aiming to discover patterns, structures, or relationships within the dataset. Clustering and dimensionality reduction are common tasks in unsupervised learning, helping to reveal inherent structures without predefined target labels. The typical process for unsupervised learning includes: data collection, analysis (e.g., using clustering, dimensionality reduction, etc.) and association. For example, machine learning module 110 receives a dataset including only input features without corresponding output labels. Machine learning module 110 then performs exploratory data analysis to understand the inherent structure of the data. Common techniques in this analysis include statistical measures, clustering, and dimensionality reduction. For example, in clustering, the algorithm groups similar data points together based on certain features. Algorithms including, but not limited to, k-means clustering and hierarchical clustering are commonly used for grouping. In dimensionality reduction, the algorithm reduces the number of input features while retaining essential information. For example, the algorithm may use techniques like Principal Component Analysis (PCA) or t-distributed Stochastic Neighbor Embedding (t-SNE) for dimensionality reduction. During the association phase, the algorithm discovers relationships or associations between variables in the analyzed data. In some aspects, unsupervised learning is used in generative neural networks (e.g., generative adversarial networks (GANs)) to generate new data points similar to the existing dataset once the characteristics of the existing dataset are learned.

Reinforcement learning is applied in scenarios where the optimal decision-making strategy is learned through trial and error, without explicit guidance. It finds applications in various domains, including robotics, game playing, and autonomous systems. More specifically, reinforcement learning involves an agent learning to make decisions by interacting with an environment. The agent receives feedback in the form of rewards or penalties based on its actions, allowing it to learn optimal strategies through trial and error. The primary components of reinforcement learning are as follows: agent, environment, state, action, reward, exploration and exploitation, learning policy, and value function. An agent is the entity that takes actions in the environment. It's the learner in the system. The environment is the external system with which the agent interacts. It provides feedback to the agent based on the actions taken. The state is a representation of the current situation or configuration of the environment. Actions are the moves or decisions that the agent can take within the environment. A reward is a numerical signal that indicates the immediate benefit or cost of the agent's action. The agent's objective is to maximize the cumulative reward over time. The reinforcement learning process typically involves the following steps. The agent explores the environment to discover the most rewarding actions (exploration) and exploits its current knowledge to take actions it believes will yield the highest cumulative reward (exploitation). The agent learns a policy, which is a strategy that maps states to actions, based on the observed rewards and its exploration-exploitation trade-offs. The agent may also learn a value function, estimating the expected cumulative reward from a given state or state-action pair.

In machine learning, training involves optimizing the model's parameters to minimize a chosen objective function, often a loss function. Some training formulas and concepts that machine learning module 110 may execute include linear regression loss, logistic regression loss, reinforcement learning, and neural network loss.

For linear regression, Mean Squared Error (MSE) is a common loss function.

$$MES = \frac{1}{n} {\sum }_{i = 1}^{n} {( {y}_{i} - {\hat{y}}_{i} )}^{2} ,$$

where yi is the true output, y\hat{ }i is the predicted output, and n is the number of samples.

For binary classification in logistic regression, the Binary Cross-Entropy Loss is frequently used.

$$Binary Cross - Entropy = - \frac{1}{n} {\sum }_{i = 1}^{n} [ {y}_{i} log ( {\hat{y}}_{i} ) + ( 1 - {y}_{i} ) log ( 1 - {\hat{y}}_{i} ) ] ,$$

where yi is the true label (0 or 1), y\hat{ }i is the predicted probability, and n is the number of samples.

In neural networks, the cross-entropy loss is common for classification tasks. Cross-

$$Entropy = -- \frac{1}{n} {\sum }_{i = 1}^{n} {\sum }_{j = 1}^{C} {y}_{ij} log ( {\hat{y}}_{ij} ) ,$$

where yij is the true probability of class j, y\hat{ }ij is the predicted probability, n is the number of samples, and C is the number of classes.

In reinforcement learning, the objective is often to maximize the expected cumulative reward. The Q-learning update rule is an example:

$$Q ( s , a ) ← Q ( s , a ) + α [ r + γ {max}_{{a}^{′}} Q ( {s}^{′} , {a}^{′} ) - Q ( s , a ) ] ,$$

where Q(s,a) is the action-value function, a is the learning rate, r is the immediate reward, y is the discount factor, s′ is the next state, and a′ is the next action.

These formulas represent the core optimization objectives in different machine learning scenarios, and the choice depends on the specific task and model architecture.

Machine learning module 110 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 110 may be one of the following: a feedforward neural network (FNN), convolution neural network (CNN), recurrent neural network (RNN), long short-term memory (LSTM) network, gated recurrent unit (GRU) network, autoencoder, generative adversarial network (GAN).

An FNN is the simplest form of neural network, where information travels in one direction—from the input layer through hidden layers to the output layer. An FNN is commonly used for tasks like classification and regression.

A CNN is specialized for processing grid-like data, such as images, and employs convolutional layers to learn spatial hierarchies of features, reducing the need for manual feature engineering. CNNs are well-suited for tasks like image classification, object detection, and image generation.

An RNN is designed for sequential data, where the order of inputs matters. An RNN includes loops in the network architecture to allow information to persist, and is useful for tasks like natural language processing, speech recognition, and time-series prediction.

A LSTM network is an extension of an RNN designed to overcome the vanishing gradient problem. LSTMs have memory cells that can store and retrieve information over long sequences, making them effective for capturing long-term dependencies in sequential data.

A GRU Network is similar to LSTMs and are another type of RNN with mechanisms to address the vanishing gradient problem. GRUs have a simpler architecture with fewer parameters compared to LSTMs.

An autoencoder is a type of neural network used for unsupervised learning and dimensionality reduction, and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

FIG. 2A is a diagram illustrating a UI accepting a topic selection. The UI in FIG. 2A corresponds to UI 106 generated on computing device 101a. UI 106 (as shown in FIG. 2A) displays text stating “enter a topic or select from the dropdown menu” and provides two input options right below. UI 106 may receive a text input in textbox 202 (e.g., the user may enter the text “Biology”) or may receive a selection from the plurality of topics listed in menu 204 (e.g., the user may scroll through the menu and select “Biology”). UI 106 receives confirmation of the selection via the selection of the “start” button 206.

FIG. 2B is a diagram illustrating a UI accepting reference materials for a new topic. UI 106 (as shown in FIG. 2B) displays text stating “create a new topic,” and provides field 208 where a user may upload reference materials. For example, UI 106 may receive a collection of slide deck(s), text document(s), graphic(s), etc., that are uploaded by the user from a local storage (e.g., a local hard drive) or a cloud storage (e.g., an online data storage service). Additionally or alternatively, the user may provide Internet-based links (e.g., URL) to said references via field 210.

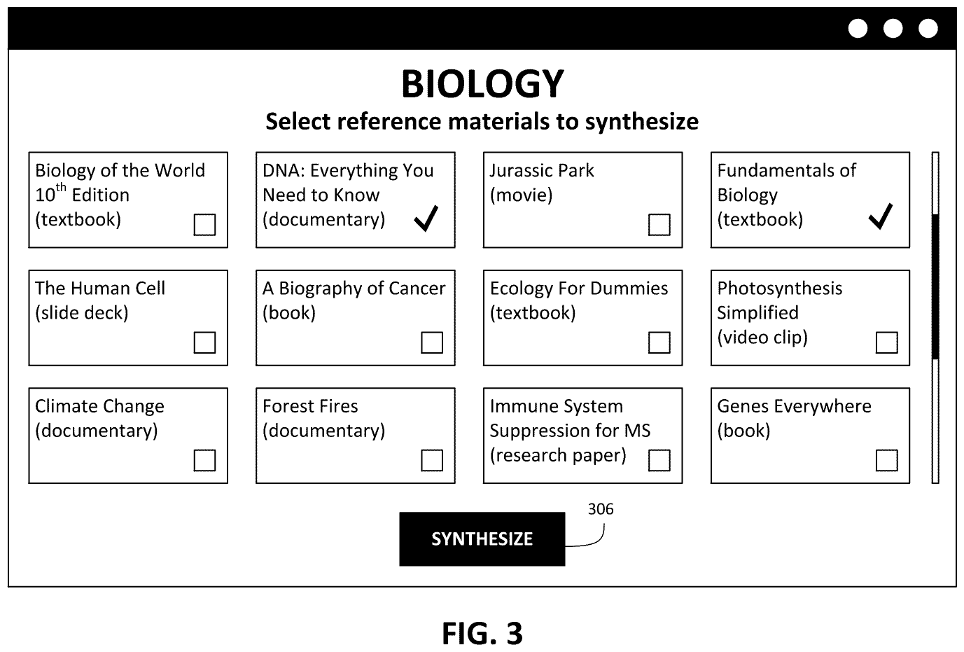

FIG. 3 is a diagram illustrating the UI receiving reference material selections for synthesis. One of the features offered by UI 106 is the customization of content presented to the user. For example, there are several reference materials associated with the topic “biology” taken from database 118 and presented on UI 106. Materials may be text-based or image-based (e.g., textbooks, books, papers, slide decks, etc.), video-based (e.g., video clip, movie, documentary, etc.), audio-based (e.g., songs, sound clips, etc.), or game-based. In each case, machine learning module 110 extracts the text to be synthesized. For example, machine learning module 110 may apply a video-to-text, audio-to-text, and image-to-text conversion on each reference material depending on its type. If the reference material is a slide deck, for example, content generator 114 may extract the text in the textboxes, describe the contents of an image in a text format, parse the audio in any embedded video/audio into text, etc. In FIG. 3, the user selects the documentary “DNA: Everything You Need to Know” and the textbook “Fundamentals of Biology.” Solely these references are used to synthesize content for the user. In some aspects, the user may upload additional reference material(s) not in the list.

FIG. 4 is a diagram illustrating the UI displaying a generated course. More specifically, UI 106 generates a course that includes an initial syllabus and initial course content generated based on selections of the topic and, optionally, sub-topic(s). For example, factors such as duration and difficulty may be default values such as 30 hours and 5/10, respectively. As shown in FIG. 4, UI 106 displays panels 402, 404, and 406. Each panel is ordered in the manner indicated by the generated syllabus (e.g., “atomic structure,” followed by “chemical bonds,” followed by “energy and ecosystems”). Each panel includes course content, which includes any combination of text, graphics (e.g., images, videos, animations, etc.), interactive plug-ins (e.g., games, etc.), etc., extracted from the reference materials associated with the sub-topics. Each panel further includes reference materials button 408, which allows a user to access the reference materials directly, and may indicate the portions that the user is recommended to read/view/listen to in the reference materials. For example, the user may review panel 406, which includes the course content generated by content generator 114. The user may then select reference materials button 408, which directs the user to a website that includes recommended supplemental material to learn more about the sub-topic. Likewise, UI 106 may receive a selection of questions button 410, which results in an output of questions generated by assessment generator 116.

In an exemplary aspect, UI 106 displays preferences panel 412, which allows the user to customize the course displayed on UI 106. For example, a user may adjust the duration associated with the course by entering a duration value in duration adjuster 414 (e.g., the user may enter a text input or slide the slider). The user may also adjust the difficulty of the course by entering a difficulty value in difficulty adjuster 416.

Lastly, the user may upload the reference material that he/she would like to incorporate in the content generated by content generator 114. For example, the user upload a slide deck via panel 418. Accordingly, the text, graphics, etc., shown in the panels 402, 404, and 406 may dynamically change to incorporate the contents of the uploaded slide deck. Similarly, the user may provide an Internet-based link to the reference material via panel 418.

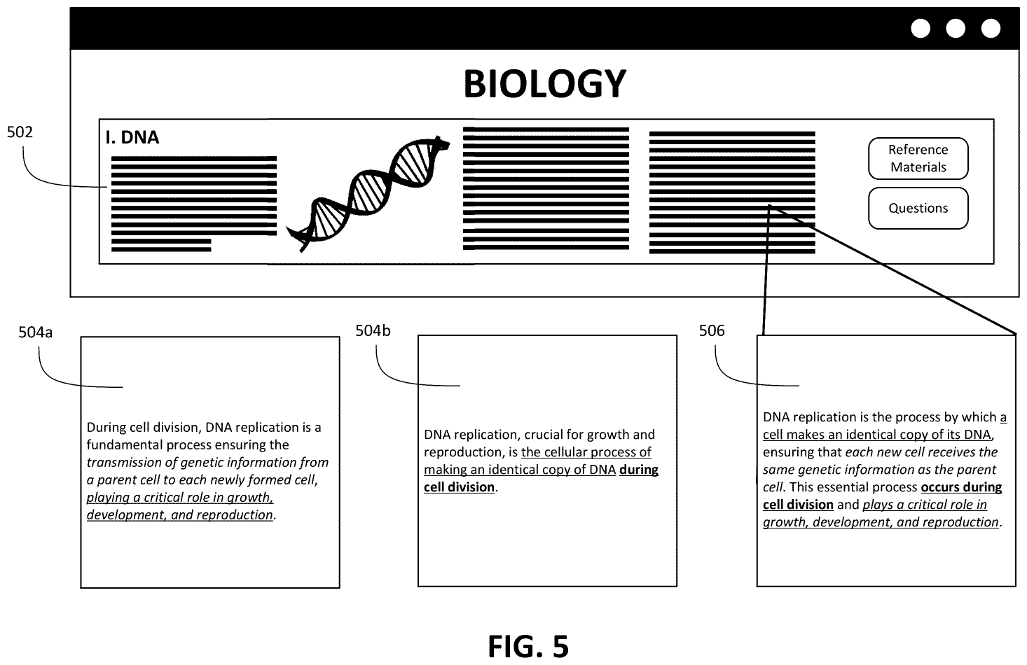

FIG. 5 is a diagram illustrating content from two different reference materials being synthesized for display on the UI. For example, panel 502 is similar in structure to panel 402. The sub-topic described in DNA. Suppose that content generator 114 extracts text from a first reference material (e.g., the selected documentary in FIG. 3) and a second reference material (e.g., the selected textbook in FIG. 3). Passage 504a originates from the first reference material and passage 506b originates from the second reference material. Synthesized passage 506 is generated for display in panel 502 by content generator 114 using passages 504a and 504b. In particular, content generator 114 borrows certain language from each of the passages and also adds linking phrases to stitch the borrowed language. For example, passage 504a states “transmission of genetic information from a parent cell to each newly formed cell,” which is presented in passage 506 by content generator 114 as “each new cell receives the same genetic information as the parent cell.” Passage 504a further states “playing a critical role in growth, development, and reproduction,” which is presented in passage 506 by content generator 114 as “plays a critical role in growth, development, and reproduction.” Passage 504b states “the cellular process of making an identical copy of DNA,” which is presented in passage 506 by content generator 114 as “a cell makes an identical copy of its DNA.” Passage 504b further states “during cell division,” which is presented in passage 506 by content generator 114 as “occurs during cell division.”

The length of passage 506 (e.g., the amount of words used) and the complexity level associated with passage 506 may be adjusted by the user according to preference. It should be noted that rather than reading the entirety of the first and second reference materials, the user is presented with the most relevant material in synthesized passage 506, which is further customizable and simplifies the output shown on the UI.

In the ever-evolving landscape of education, the role of user interfaces (UIs) in presenting educational material has become increasingly pivotal. With the proliferation of digital platforms and online learning tools, the manner in which information is synthesized and presented to learners plays a critical role in their comprehension and retention. However, despite the abundance of resources available, many conventional GUIs fall short in effectively synthesizing information into a cohesive educational body. This failure to seamlessly integrate diverse content into a unified learning experience poses significant challenges for learners seeking clarity and depth in their educational pursuits.

Several technical shortfalls of conventional GUIs contribute to their inability to effectively synthesize information into a cohesive educational body. Firstly, there may be compatibility issues between materials of various file formats, APIs, or data sources, making it challenging to consolidate information from different platforms or disciplines. Conventional GUIs may encounter difficulties in processing large volumes of data efficiently. This can result in slow processing speeds, frequent crashes, or incomplete synthesis, hindering the creation of comprehensive educational materials. In another example, natural language processing (NLP) capabilities are crucial for understanding and summarizing text-based content. However, GUIs using poor NLP approaches often exhibit limitations in accurately interpreting and summarizing complex language structures, leading to inaccuracies or misinterpretations in synthesized material. Effective synthesis requires an understanding of the context in which information is presented. Content synthesizers may struggle to discern nuances, cultural references, or contextual cues, leading to disjointed or irrelevant synthesis outputs. Modern educational content often incorporates multimedia elements such as images, videos, and interactive simulations. Conventional GUIs may lack robust capabilities to integrate and contextualize multimedia content effectively, diminishing the richness of the educational experience.

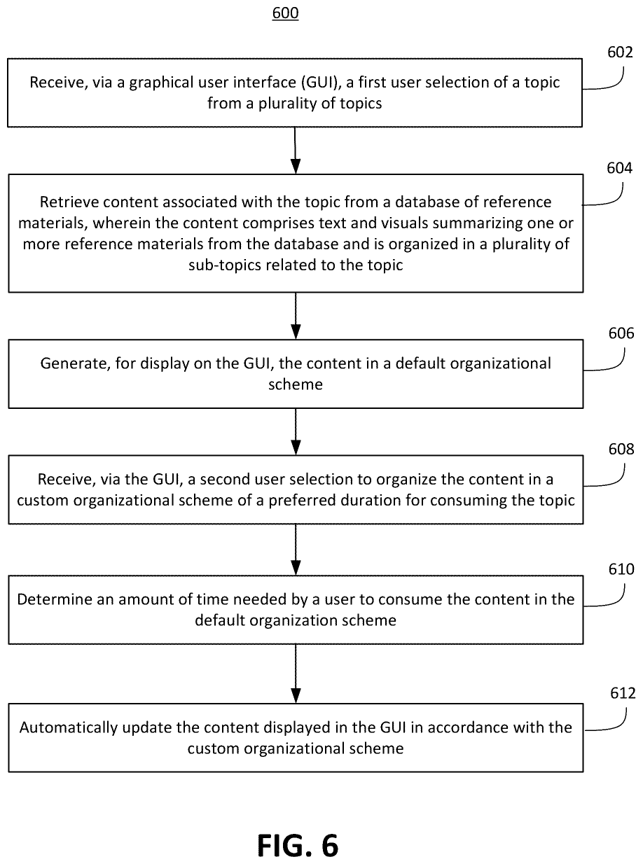

FIG. 6 is a block diagram illustrating method 600 for updating a UI displaying content related to a topic based on user preference. At 602, course generator 102 receives, via UI 106, a first user selection of a topic from a plurality of topics. At 604, course generator 102 identifies a first reference material and a second reference material from a plurality of reference materials related to the topic.

In some aspects, identifying the first reference material and the second reference material comprises course generator 102 receiving, via the UI 106, a preferred complexity level of the synthesized content. Course generator 102 searches (e.g., database 118) for two or more reference materials with complexity levels matching the preferred complexity level. Course generator 102 thus identifies, based on the searching, the first reference material and the second reference material.

In some aspects, identifying the first reference material and the second reference material comprises course generator 102 generating, for display on UI 106, at least a portion of each of the plurality of reference materials. Course generator 102 receives, via UI 106, a selection of a subset of reference materials from the plurality of reference materials, wherein the first reference material and the second reference material are in the subset of reference materials.

In some aspects, identifying the first reference material comprises course generator 102 receiving, via the UI 106, at least one of the first reference material or a link to the first reference material.

At 606, course generator 102 determines a first accuracy level (e.g., 8/10) and a first quality level (e.g., 7/10) of the first reference material. At 608, course generator 102 determines a second accuracy level (e.g., 10/10) and a second quality level (e.g., 10/10) of the second reference material.

In some aspects, course generator 102 determines the first accuracy level and the second accuracy level comprises executing a second machine learning algorithm trained to generate an accuracy level based on one or more of an input genre of a given reference material, a fact checking score of the given material, and a publication date of the given reference material.

In some aspects, course generator 102 determines the first quality level and the second quality level comprises executing a third machine learning algorithm trained to generate a quality level based on online reviews comprising user ratings and written descriptions. In some aspects, course generator 102 first web crawls the online reviews and parses the online reviews by: determining a frequency of words in the online reviews; and identifying trigger words indicative of low quality in the online reviews. Course generator 102 then includes frequencies of the trigger words and the user ratings in an input vector for the third machine learning algorithm to output the quality level.

At 610, course generator 102 calculates a weight distribution that is a combination of a ratio between the first accuracy level and the second accuracy level and a ratio between the first quality level and the second quality level. For example, the accuracy ratio may be 8:10 and the quality ratio may be 7:10. The weight distribution may be an average of these ratios (e.g., 7.5:10).

At 612, course generator 102 executes, by a hardware processor, a first machine learning algorithm that generates content synthesized from both the first reference material and the second reference material based on the weight distribution. For example, the first machine learning algorithm may extract sentences from each of reference materials at a ratio of 7.5:10 (e.g., 7.5 sentences from the first reference material for each set of 10 sentences extracted from the second reference material). The first machine learning algorithm may further use its generative properties to merge the concepts from each of the sentences into one cohesive synthesized content.

At 614, course generator 102 outputs, for display on the UI, the content synthesized from both the first reference material and the second reference material.

It should be noted that although the example given in example 600 only features two reference materials, the concepts may be apply to any number of reference materials (e.g., determining accuracy levels and quality levels of all references, and determining ratios across all references).

In some aspects, the topic comprises a plurality of sub-topics. The information of each sub-topic in the plurality of sub-topics is outputted in a different visual panel of the UI. Moreover, the respective content for each sub-topic may be synthesized from a different subset of reference materials from the plurality of reference materials. For example, for one sub-topic, textbooks 1, 2, and 3 may be used. For another sub-topic, textbooks 5 and 6 may be used. For yet another sub-topic, documentary 1 and textbook 4 may be used.

In some aspects, course generator 102 receives, via the UI, a user selection of a preferred duration of the content. Course generator 102 may then adjust a length of the content such that it is consumed within the preferred duration.

In some aspects, using machine learning, course generator 102 may load reference materials as complete texts or in specific modes (e.g., presentation mode comprising graphics and text, video mode comprising clips, document mode comprising solely text). If one or more machine learning models cannot process the volume of information, course generator 102 may execute compression techniques to meet input size requirements. Said compression techniques may involve any combination of text summarization, ranking/reranking of materials, retrieval augmented generation (RAG), graphing, text splitting (e.g., provide the referenced material in parts or with highlighted relevant content).

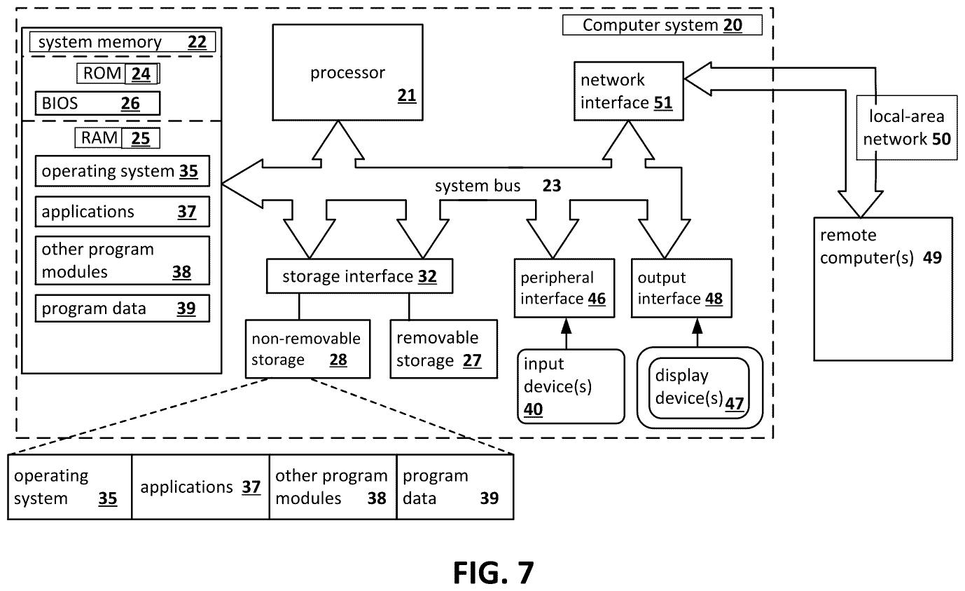

FIG. 7 is a block diagram illustrating a computer system 20 on which aspects of systems and methods for generating custom courses on a user interface using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

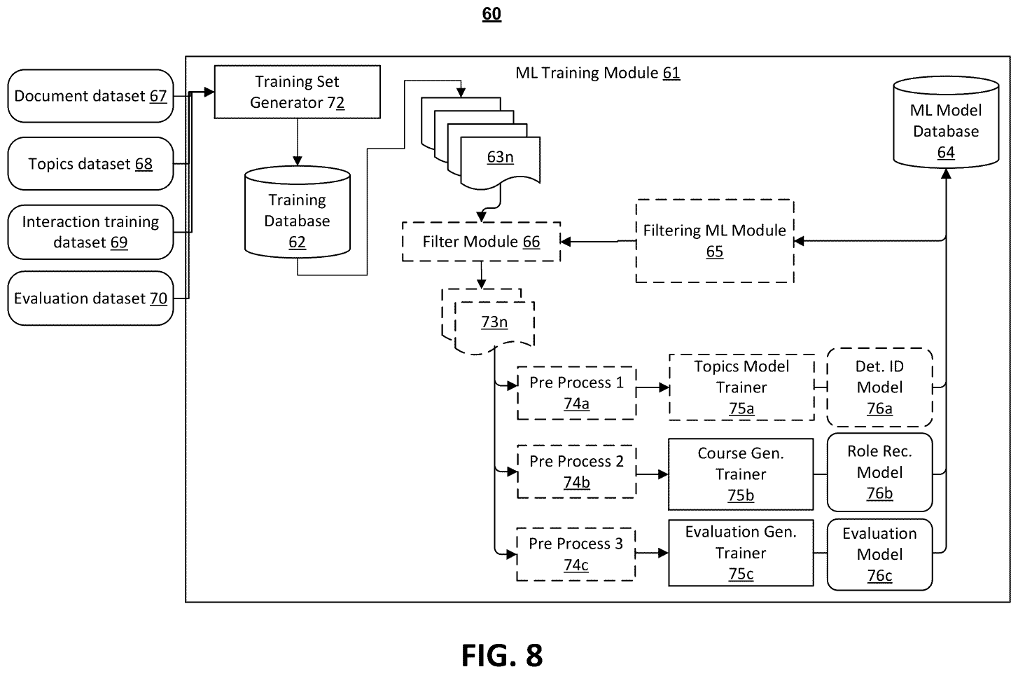

FIG. 8 is a block diagram illustrating a system 60 for training course generator 102 to generate custom courses according to aspects of the present disclosure. As shown in example 60, a ML training module 61 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained image data sets, the specialized machine learning models may perform particular tasks such as course generation.

Supervised learning is effective for tasks such as classification (assigning inputs to predefined categories) and regression (predicting continuous values) since it relies on the availability of labeled data for both training and evaluation phases. In supervised learning, the ML training module 61 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 61 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 61 includes at least a training database 62 configured to store the raw training data 63n and corresponding labels, a ML model database 64 to store the trained models (e.g., model 76a, 76b, 76c, etc.). In some aspects, the ML training module 61 may include a filtering machine learning model 65 and a filter module 66 configured to filter data from the training database 62 for training by removing poorly generated training data.

Training data from the document dataset 67, topics dataset 68, interaction training dataset 69, and evaluation dataset 70 is received into the ML training module 61 via the training set generator 72. In some aspects, document dataset 67 includes documents and summarized versions of said documents, topics dataset 68 includes text and identified topics in the text, interaction training dataset 69 includes clickstream user data on the UI, and evaluation dataset 70 including question and answer student performance.

An optional filter module 66 is configured to filter out bad training images and/or data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a, preprocess 2 74b, and preprocess 3 74c are automated processes that modify the raw data received from 63n (or cleaned training dataset 73n) and prepare the raw data as input to the respective model trainers (e.g., a people/object detection model trainer 75a, a role recognition model trainer 75b, and an evaluation model trainer). These may be described in the machine learning training module 61 as snippets of code that prepares the datasets. In some examples, the preprocessing module (e.g., preprocess 174a, preprocess 2 74b, and preprocess 3 74c) for a particular trainer may be an automated script or code that will be setup the first time any model is trained.

The topics model trainer 75a, course generation trainer 75a, and evaluation generation trainer 75c are the scripts or code that train the model. The topics model trainer 75a, course generation trainer 75a, and evaluation generation trainer 75c may be a script or code that holds the instructions on how a model should be trained (e.g., optimization method, model architecture, dataset division, etc.) and also runs the training. The topics model trainer 75a, course generation trainer 75a, and evaluation generation trainer 75c each take as input the raw or filtered processed training data and train topics model 76a, course generation model 76b, and evaluation generation model 76c to achieve their specific objectives, respectively.

In summary, the raw dataset 63n or cleaned dataset 73n may optionally go through different preprocessing steps 74a, 74b, and 74c and then a corresponding topics model trainer 75a, course generation trainer 75a, and evaluation generation trainer 75c to generate a trained model 76a, a trained course generation model 76b, and a trained evaluation generation model 76c. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for training may include noise and bad training images from the training database 62. Accordingly, to create a clean and filtered training dataset, the filter module 66 is configured to filter out unwanted data points from the raw training dataset 63n by developing smaller, less accurate systems based on patterns and metadata information.

During the training process, topics model trainer 75a, course generation trainer 75a, and evaluation generation trainer 75c (e.g., neural networks) are presented with input data and labels of actual values, and the optimization objective, which aims to minimize the difference between the actual value and the predicted value, is calculated. The optimization algorithm updates the parameters of topics model trainer 75a, course generation trainer 75a, and evaluation generation trainer 75c to reduce the value of the objective. This process is repeated for several iterations until the parameters do not change anymore. This process is repeated for various combinations of hyperparameters, and the model with the smallest label prediction error is selected as the final model.

When a new model (e.g., a trained topics model 76a, a trained course generation model 76b, and a trained evaluation generation model 76c) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating synthesized content using machine learning, the method comprising:
receiving, via a user interface (UI), a first user selection of a topic from a plurality of topics;
identifying a first reference material and a second reference material from a plurality of reference materials related to the topic;
determining a first complexity level and a first quality level of the first reference material;
determining a second complexity level and a second quality level of the second reference material;
calculating a weight distribution that is a combination of a ratio between the first complexity level and the second complexity level and a ratio between the first quality level and the second quality level;
executing, by a hardware processor, a first machine learning algorithm that generates content synthesized from both the first reference material and the second reference material based on the weight distribution; and
outputting, for display on the UI, the content synthesized from both the first reference material and the second reference material.

2. The method of claim 1, wherein calculating the weight distribution further comprises:
determining a first accuracy level of the first reference material;
determining a second accuracy level of the second reference material; and
calculating the weight distribution further based on a ratio between the first accuracy level and the second accuracy level.

3. The method of claim 1, wherein identifying the first reference material and the second reference material comprises:
generating, for display on the UI, at least a portion of each of the plurality of reference materials; and
receiving, via the UI, a selection of a subset of reference materials from the plurality of reference materials, wherein the first reference material and the second reference material are in the subset of reference materials.

4. The method of claim 1, wherein identifying the first reference material comprises:
receiving, via the UI, at least one of the first reference material or a link to the first reference material.

5. The method of claim 2, wherein determining the first accuracy level and the second accuracy level comprises:
executing a second machine learning algorithm trained to generate an accuracy level based on one or more of an input genre of a given reference material, a fact checking score of the given material, and a publication date of the given reference material.

6. The method of claim 1, wherein determining the first complexity level and the second complexity level comprises:
executing a second machine learning algorithm trained to generate a complexity level based on one or more of: (1) a number of terms, topics, subtopics used in a given reference material, (2) an amount of time needed to complete the given reference material, (3) expert estimations, (4) large language model (LLM) output, (5) grades of students in exams of a corresponding topic covered in the given reference material, (6) complexity levels of reference materials used in required prerequisites of a course.

7. The method of claim 1, wherein determining the first quality level and the second quality level comprises:
executing a third machine learning algorithm trained to generate a quality level based on online reviews comprising user ratings and written descriptions.

8. The method of claim 7, further comprising:
web crawling the online reviews;
parsing the online reviews by:
determining a frequency of words in the online reviews; and
identifying trigger words indicative of low quality in the online reviews; and
including frequencies of the trigger words and the user ratings in an input vector.

9. The method of claim 1, wherein the topic comprises a plurality of sub-topics, wherein information of each sub-topic in the plurality of sub-topics is outputted in a different visual panel of the UI.

10. The method of claim 9, wherein respective content for each sub-topic is synthesized from a different subset of reference materials from the plurality of reference materials.

11. The method of claim 1, further comprising:
receiving, via the UI, a user selection of a preferred duration of the content; and
adjusting a length of the content such that it is consumed within the preferred duration.

12. A system for generating synthesized content using machine learning, comprising:
at least one memory; and
at least one hardware processor coupled with the at least one memory and configured, individually or in combination, to:
receive, via a user interface (UI), a first user selection of a topic from a plurality of topics;
identify a first reference material and a second reference material from a plurality of reference materials related to the topic;
determine a first complexity level and a first quality level of the first reference material;
determine a second complexity level and a second quality level of the second reference material;
calculate a weight distribution that is a combination of a ratio between the first complexity level and the second complexity level and a ratio between the first quality level and the second quality level;
execute a first machine learning algorithm that generates content synthesized from both the first reference material and the second reference material based on the weight distribution; and
output, for display on the UI, the content synthesized from both the first reference material and the second reference material.

13. The system of claim 12, wherein the at least one hardware processor is configured to calculate the weight distribution by:
determining a first accuracy level of the first reference material;
determining a second accuracy level of the second reference material; and
calculating the weight distribution further based on a ratio between the first accuracy level and the second accuracy level.

14. The system of claim 12, wherein the at least one hardware processor is configured to identify the first reference material and the second reference material by:
generating, for display on the UI, at least a portion of each of the plurality of reference materials; and
receiving, via the UI, a selection of a subset of reference materials from the plurality of reference materials, wherein the first reference material and the second reference material are in the subset of reference materials.

15. The system of claim 12, wherein the at least one hardware processor is configured to identify the first reference material by:
receiving, via the UI, at least one of the first reference material or a link to the first reference material.

16. The system of claim 13, wherein the at least one hardware processor is configured to determine the first accuracy level and the second accuracy level by:
executing a second machine learning algorithm trained to generate an accuracy level based on one or more of an input genre of a given reference material, a fact checking score of the given material, and a publication date of the given reference material.

17. The system of claim 12, wherein the at least one hardware processor is configured to determine the first complexity level and the second complexity level by:
executing a second machine learning algorithm trained to generate a complexity level based on one or more of: (1) a number of terms, topics, subtopics used in a given reference material, (2) an amount of time needed to complete the given reference material, (3) expert estimations, (4) large language model (LLM) output, (5) grades of students in exams of a corresponding topic covered in the given reference material, (6) complexity levels of reference materials used in required prerequisites of a course.

18. The system of claim 12, wherein the at least one hardware processor is configured to determine the first quality level and the second quality level by:
executing a third machine learning algorithm trained to generate a quality level based on online reviews comprising user ratings and written descriptions.

19. The system of claim 18, wherein the at least one hardware processor is configured to:
web crawl the online reviews;
parse the online reviews by:
determining a frequency of words in the online reviews; and
identifying trigger words indicative of low quality in the online reviews; and
include frequencies of the trigger words and the user ratings in an input vector.

20. The system of claim 12, wherein the topic comprises a plurality of sub-topics, wherein information of each sub-topic in the plurality of sub-topics is outputted in a different visual panel of the UI.

21. A non-transitory computer readable medium storing thereon computer executable instructions for generating synthesized content using machine learning, including instructions for:
receiving, via a user interface (UI), a first user selection of a topic from a plurality of topics;
identifying a first reference material and a second reference material from a plurality of reference materials related to the topic;
determining a first complexity level and a first quality level of the first reference material;
determining a second complexity level and a second quality level of the second reference material;
calculating a weight distribution that is a combination of a ratio between the first complexity level and the second complexity level and a ratio between the first quality level and the second quality level;
executing, by a hardware processor, a first machine learning algorithm that generates content synthesized from both the first reference material and the second reference material based on the weight distribution; and
outputting, for display on the UI, the content synthesized from both the first reference material and the second reference material.
